(19) United States
(12) Patent Application Publication
(10) Pub. No.: US 2007/0157670 A1
(43) Pub. Date: Jul. 12, 2007

(54) Superhard mold face for forming ele

(76) Inventor: Chien-Min Sung, Taipei County (TW)

Correspondence Address: THORPE NORTH & WESTERN, LLP., 8180 SOUTH 700 EAST, SUITE 200, SANDY, UT, 84070, US

(21) Appl. No.: 11/323,996

(22) Filed: Dec. 30, 2005

(51) Int. Cl. C03B 23/00; A23G 1/22; C03B 11/08; C03B 7/14

(52) U.S. Cl. 65/102; 65/374.13; 65/374.15; 425/121

(57) ABSTRACT

Mold assemblies for forming optical elements including a support material and a molding material are disclosed and described. In one aspect, the molding material can include a single crystal diamond coupled to the support material and includes a working surface defining a shape to be imparted to an optical element to be pressed in the mold assembly. In another aspect, the molding material can include a PCD compact coupled to the support material and includes a working surface defining a shape to be imparted to an optical element to be pressed in the mold assembly. In yet a further aspect, the molding material may include a cermet composite coating material which provides a gradient of one material coupled to the support material to another material at a working surface of the molding material which defines a shape to be imparted to an optical element to be molded.

### FIELD OF THE INVENTION

The present invention relates to mold assemblies having superhard working surfaces for use in forming optical elements and other at least partially spherical elements. Accordingly, the present invention involves the fields of chemistry, physics, and materials science.

### BACKGROUND OF THE INVENTION

Press molds are widely used in the manufacture of various parts which are desired to be produced with relatively high throughput. For example, injection molding of polymer materials for sealing semiconductor devices (e.g. diodes) is a routine production practice. Ophthalmic lenses are also molded in a similar fashion. In recent years, relatively small camera lenses, such as those used in cell phones and similar devices, have been produced in large quantities. Such lenses may be made of transparent polymers or optical glasses. In a typical application, raw material in the form of a bead is pressed and flattened between two anvils in order to form a lens from the raw material. Anvils used in such a process generally have concave recessions that are precisely ground and polished to specific profiles (e.g. spherical or non-spherical profiles). The resulting lens formed between the anvils exhibits a curvature matching the profiles of the anvils.

When the lens is used as a lens in a digital camera or a cell phone, the image passing through the lens must often be processed to millions of pixels (on the order of 130 million for many cell phones). Consequently, it is desired that the light path of the image be meticulously controlled. In order to achieve this level of quality, the uniformity of the lens material must be extremely high and the surface of the lens must be very smooth.

In order to meet the rigid demands of bulk uniformity and surface smoothness, the mold material must be very rigid so it does not yield under compression (thus assuring dimensional repeatability). In addition, the mold surface should be relatively consistent, or at least there must be very few, or preferably no, “soft spots” on the mold. In addition, the mold surface should be highly inert so that it does not react with the lens material being molded. Without such inertness, a parting agent may have to be applied (e.g. aerosol of hexagonal boron nitride powder). However, the addition of a parting agent may reduce throughput times and may also affect the surface quality of the lens. As the small lens must divide light into millions of pixels, any small aberration or surface defect (e.g. unremoved parting agent) can be very problematic.

In addition to the requirements that the mold material be rigid and smooth, the mold material must generally be thermally stable without mechanical yielding (e.g. deformation) or chemical reaction (e.g. oxidation). This is because the molding process of the lens is generally accompanied by heating of the optical material. Heating of the optical material is necessary in order to soften the deformed material. Otherwise, the material would be less plastic and it may not flow into all areas defined by the mold cavity. Moreover, shear stress resulting from deformation of the lens material when in an unheated state is not released during deformation of the lens material, resulting in distortion of the lens after the material has been pressed. The internal stress will also affect the refractive index of the lens, resulting in varying optical properties across the lens and also resulting in the lens being directionally dependent, e.g., anisotropic. All these aberrations are generally unacceptable in forming high precision lenses.

The material used to form optical lenses of these types is generally either polymeric or glass. Polymer materials are relatively less expensive and have lower melting points, so they can be plastically deformed at relatively low temperatures (e.g. <400° C.). However, the refractive index of polymers is generally low. Polymer lenses are often also too soft to withstand scratches from dirt, dust, etc. Hence, high precision lenses used today are generally formed of specialty optical glass.

This optical glass has a much higher molding temperature (e.g. 700° C.) than polymer materials. Most mold materials (e.g. tool steel, super alloys) cannot withstand extended use in such extreme temperature ranges. Even cemented tungsten carbide (cWC) commonly used in the best currently available molds may be softened under such use. In light of this, the industry has resorted to using cWC with very little cobalt content. In such an application, submicron WC particles are often used to minimize the grain effect on the mold surface. Even when so configured, however, the mold can last for only a few hundreds “runs” (the life of a typical steel mold is only on the order of ten runs). Accordingly, conventional molds formed in such a manner must be replaced very frequently.

Thus, current optical lens mold makers have been faced with the problem of increasing the hardness and surface smoothness of molds in order to meet the ever increasing demands for optical integrity, while also utilizing improved optical materials that demand very high operating temperatures. For example, in attempts to improve the wear resistance and surface inertness of press molds, diamond-like-carbon (“DLC”) film has been applied to mold materials. However, DLC often cannot withstand temperatures higher than about 400° C. in repeated cycling.

In addition, DLC is generally very thin (e.g. <1 micron), so its overall wear resistance is limited. Also, DLC is notoriously difficult to adhere to the substrates used in press molding optical lenses. During the thermal cycling of the molding process, the thermal mismatch between low expansion DLC and a high expansion substrate can cause stress fatigue resulting in “flaking” of the DLC coating. Furthermore, the surface atoms of DLC contain dangling electrons that are reactive to molding materials as well as moisture in air. Due to these dangling electrons, reaction may result causing pitting of either the molding material or the DLC.

Thus, improved optical lens materials provide lenses with high thermal stability and chemical inertness. However, the improved optical qualities have generally come at the cost of raising the melting point of the glass used as a lens material. In order to address these conflicting goals, the mold material used to form optical elements must itself be much stronger and have much higher thermal stability than mold materials currently being used.

### SUMMARY OF THE INVENTION

Accordingly, the present invention provides mold assemblies for forming optical elements, including a support material and a molding material. In one aspect, the molding material can include a single crystal diamond coupled to the support material and can include a working surface defining a shape to be imparted to an optical element pressed in the mold assembly.

In accordance with a more detailed aspect of the invention, a (111) face of the single crystal diamond can be oriented toward an axis of compression of the mold assembly.

In accordance with another aspect of the invention, a mold assembly for forming optical elements is provided, including a support material and a molding material. The molding material can include a PCD compact coupled to the support material and can include a working surface defining a shape to be imparted to an optical element to be pressed in the mold assembly. In some cases, a superhard film can be applied over the working surface of the PCD molding material to improve the smoothness of the interface between the mold assembly and the optical element.

In accordance with a more detailed aspect of the invention, the superhard film can be a diamond film or a diamond-like carbon film. The diamond-like carbon film can further include nitrogen to aid in the formation of CN.

In accordance with a more detailed aspect of the invention, the PCD compact can include ceramic material as a sintering aid which is a member selected from the group consisting of: SiC, TiC, TiN, Si₃N₄, AlN, WC and Al₂O₃. The PCD can further include an electrically conducting metal to facilitate electrical discharge machining of the PCD. In one aspect, such a metal may include Ti or W.

In accordance with a more detailed aspect of the invention, the molding material can be brazed to the support material. The braze used can include TiCuSi or CuSnTi and the molding material can be brazed to the support material under vacuum.

In accordance with a more detailed aspect of the invention, the support material can be selected from the group consisting of: cWC; SiC, Si₃N₄, and hardened steel.

In accordance with a more detailed aspect of the invention, the working surface of the molding material is rendered non-reactive by the removal of dangling bonds from the working surface. The dangling bonds can be bound to an element having only a single valence electron. The element having a single valence electron can be hydrogen or a halogen. The halogen can be a member selected from the group consisting of: F, Cl, Br, I, and mixtures thereof.

In accordance with a more detailed aspect of the invention, a flash of noble metal can be applied to the working surface of the molding material to further smooth the optical element as it is formed in the mold assembly.

In accordance with yet another aspect of the invention, a mold assembly for forming optical elements is provided, including a support material and a molding material coupled to the support material. The molding material can include a first, working region including a superhard material and having a working surface defining a shape to be imparted to an optical element to be pressed in the mold assembly. The molding material can also include a second region and a transition region connecting the first and second regions. The transition region can have a compositional gradient from the first region to the second region.

In accordance with a more detailed aspect of the invention, the first, working region can include a material that is a member selected from the group consisting of: ceramic and diamond-containing materials, and composites thereof. Furthermore, the second region can include a ceramic material. The ceramic material can be selected from the group consisting of SiC, Si₃N₄, WC and composites thereof.

In accordance with a more detailed aspect of the invention, the first, working region can include a diamond-containing material. In one aspect, the diamond-containing material can be diamond-like carbon. The compositional gradient can be a continuous compositional gradient.

In accordance with another aspect of the invention, methods for forming an optical element is provided, including the steps of: obtaining a mold assembly as taught herein; disposing at least a portion of unformed optical material on the working surface of the molding material, and pressing the optical material in the mold assembly at a temperature sufficiently high to enable the optical material to flow.

There has thus been outlined, rather broadly, various features of the invention so that the detailed description thereof that follows may be better understood, and so that the present contribution to the art may be better appreciated. Other features of the present invention will become clearer from the following detailed description of the invention, taken with the accompanying claims, or may be learned by the practice of the invention.

### BRIEF DESCRIPTION OF THE DRAWINGS

FIG. 1 is a schematic, cross-sectional view of a mold assembly and optical element material in accordance with an embodiment of the invention; and

FIG. 2 is a schematic, cross-sectional view of another mold assembly and optical element material in accordance with an embodiment of the invention.

It will be understood that the above figures are merely for illustrative purposes in furthering an understanding of the invention. Further, the figures are not drawn to scale, thus dimensions, particle sizes, and other aspects may, and generally are, exaggerated to make illustrations thereof clearer. Therefore, departure can be made from the specific dimensions and aspects shown in the figures in order to produce the heat spreaders of the present invention.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an” and, “the” include plural referents unless the context clearly dictates otherwise. Thus, for example, reference to “a diamond particle” includes one or more of such particles, reference to “an interstitial material” includes reference to one or more of such material, and reference to “the particle” includes reference to one or more of such a particle.

Definitions

In describing and claiming the present invention, the following terminology will be used in accordance with the definitions set forth below.

As used herein, “particle” and “grit” may be used interchangeably, and when used in connection with a carbonaceous material, refer to a particulate form of such material. Such particles or grits may take a variety of shapes, including round, oblong, square, euhedral, etc., as well as a number of specific mesh sizes. As is known in the art, “mesh” refers to the number of holes per unit area as in the case of U.S. meshes. All mesh sizes referred to herein are U.S. mesh unless otherwise indicated. Further, mesh sizes are generally understood to indicate an average mesh size of a given collection of particles since each particle within a particular “mesh size” may actually vary over a small distribution of sizes.

As used herein, “substantial,” or “substantially” refers to the functional achievement of a desired purpose, operation, or configuration, as though such purpose or configuration had actually been attained. Therefore, carbonaceous particles that are substantially in contact with one another function as though, or nearly as though, they were in actual contact with one another. In the same regard, carbonaceous particles that are of substantially the same size operate, or obtain a configuration as though they were each exactly the same size, even though they may vary in size somewhat.

As used herein, “chemical bond” and “chemical bonding” may be used interchangeably, and refer to a molecular bond that exerts an attractive force between atoms that is sufficiently strong to create a binary solid compound at an interface between the atoms. Chemical bonds involved in the present invention are typically carbides in the case of diamond superabrasive particles, or nitrides or borides in the case of cubic boron nitride.

As used herein, “working surface” refers to the surface of a tool which contacts material to be formed into an optical element during a pressing procedure. In one aspect of the invention, the working surface of a tool may be a diamond or other superabrasive material layer or block of material.

As used herein, “ceramic” refers to a non-diamond, non-metallic, material, which is hard, heat resistant and corrosion resistant. Further, as used herein, “ceramic” materials may contain at least one element selected from the group consisting of Al, Si, Li, Zn, and Ga. Oxides, nitrides, and various other compounds which include the above recited elements are known ceramics to those skilled in the art. Additional materials considered to be “ceramics” as used herein, such as glass, are known to those skilled in the art. Examples of specific ceramics useful in the present invention include, without limitation, SiC, TiC, TiN, Si₃N₄, AlN, WC, Al₂O₃, etc.

As used herein, “superhard” may be used to refer to any crystalline, or polycrystalline material, or mixture of such materials which has a Mohr's hardness of about 8 or greater. In some aspects, the Mohr's hardness may be about 9.5 or greater. Such materials include but are not limited to diamond, polycrystalline diamond (PCD), cubic boron nitride (cBN), polycrystalline cubic boron nitride (PcBN) as well as other superhard materials known to those skilled in the art. Superhard materials may be incorporated into the present invention in a variety of forms including particles, grits, films, layers, etc.

As used herein, “vapor deposition” refers to a process of depositing materials on a substrate through the vapor phase. Vapor deposition processes can include any process such as, but not limited to, chemical vapor deposition (CVD) and physical vapor deposition (PVD). A wide variety of variations of each vapor deposition method can be performed by those skilled in the art. Examples of vapor deposition methods include hot filament CVD, rf-CVD, laser CVD (LCVD), laser ablation, conformal diamond coating processes, metal-organic CVD (MOCVD), sputtering, thermal evaporation PVD, ionized metal PVD (IMPVD), electron beam PVD (EBPVD), reactive PVD, and the like.

As used herein, “braze alloy” and “brazing alloy” may be used interchangeably, and refer to an alloy containing a sufficient amount of a reactive element to allow the formation of chemical bonds between the alloy and a superabrasive particle. The alloy may be either a solid or liquid solution of a metal carrier solvent having a reactive element solute therein. Moreover, the term “brazed” may be used to refer to the formation of chemical bonds between a superabrasive particle and a braze alloy.

As used herein, “sintering” refers to the joining of two or more individual particles to form a continuous solid mass. The process of sintering involves the consolidation of particles to at least partially eliminate voids between particles. Sintering may occur in either metal or carbonaceous particles, such as diamond. Sintering of metal particles occurs at various temperatures depending on the composition of the material. Sintering of diamond particles generally requires ultrahigh pressures and the presence of a carbon solvent as a diamond sintering aid, and is discussed in more detail below. Sintering aids are often present to aid in the sintering process and a portion of such may remain in the final product.

As used herein, “continuous compositional gradient” indicates a gradual change in composition, not a stepwise change or layered structure having distinct compositional or thermal expansion coefficient boundaries. Thus, the gradual change can include multiple transitions among various distinct intermediate materials or a direct gradual change from the first composition to the second target composition. As such, a “continuous compositional gradient” excludes substantially homogeneous materials, distinctly layered materials, or any materials having abrupt changes in composition or thermal expansion coefficient.

Concentrations, amounts, particle sizes, volumes, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 micrometer to about 5 micrometers” should be interpreted to include not only the explicitly recited values of about 1 micrometer to about 5 micrometers, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

The Invention

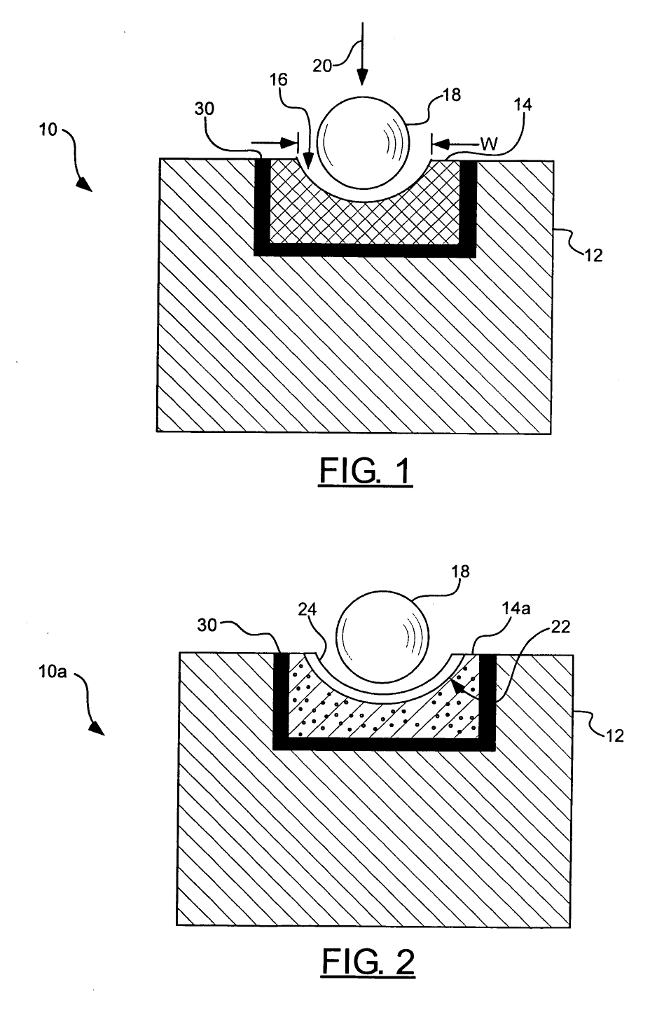

A mold assembly for forming elements such as optical elements having an inert, superhard working surface that can sustain repeated thermal and stress cycling at temperatures exceeding 400° C. can improve the quality and manufacturing throughput of optical lenses and other devices. The present invention provides such a mold assembly, and in the embodiment illustrated in FIG. 1, the mold assembly 10 for forming optical elements includes a support material 12 and a superhard molding material 14. The molding material 14 can include a single crystal diamond that can be coupled to the support material in a variety of manners, as discussed in more detail below. The molding material can include a working surface (indicated generally at 16) that can define a shape to be imparted to an optical element (not shown in finished form, but shown generally by unfinished element or optical material 18) to be pressed in the mold assembly. It will be understood by those having ordinary skill in the art that the shape imparted to the element (or optical element) by the working surfaces will generally be the inverse of the actual shape of the working surfaces.

While it is contemplated that the present invention can be advantageously used to form a variety of materials, such as forming bearing materials (e.g., ball bearings) formed from superalloy materials, in one aspect of the invention, the element or material formed is optical material 18 that is formed into an optical element. Optical material 18 shown in the accompanying figures is generally indicated in a pre-formed state illustrated schematically as spherical. In operation, the optical material will be pressed between two working surfaces 16 of the mold assembly in order to deform the glass or polymer optical material into an optical element. While the optical material can be provided in a spherical unit, it is to be understood that the optical material can be provided in a shape and form that can vary, as would occur to one having ordinary skill in the art of forming optical elements. Without regard to the beginning shape and configuration of the optical element material, once pressed between the working surfaces of the mold assembly, the optical element material will be formed into a shape defined by the working surface.

The composition of the optical material can vary as well, depending upon the process involved. In some aspects of the present invention, the optical material is an optical glass formed primarily of oxides. Generally, SiO₂ is used as the primary constituent of optical glass with various additives used to enhance the properties of the finished optical element. Al₂O₃ is often added to stabilize the structure and chemical inertness of the optical element. B₂O₃ and ZnO can be used to lower the melting temperature. K₂O, Na₂O, Li₂O, MgO, CaO and BaO can be used as flux to increase the flowability of the molten glass. PbO can be added to increase the refractive index of the glass.

It has been found that suitable optical element material has relatively high amounts of SiO₂ and Al₂O₃ with relatively lower amounts of Na₂O and K₂O. Such optical glass has been found to exhibit high thermal stability and chemical inertness. The high thermal stability can result in the lens manifesting a low thermal expansion coefficient. As a result, the refractive index of the lens is not as subject to change with varying temperature so that the focus of the lens will not be diffused in extreme weather conditions. Low thermal reactivities will assure that the lens will not be etched by repeated contact with moisture, perspiration, or other contaminants.

While such optical glass generally provides desirable operating properties, the melting point and “softening” point of such glasses is generally much higher than optical materials formed of polymers. As a result, greater stress and temperature extremes are required to form optical elements from the optical material. Accordingly, the mold materials used to form optical elements must be much stronger and have much higher thermal stability than many conventional mold materials. Even cemented tungsten carbide (cBN), which has been used due to its relatively high hardness, can become softened and pitted when press forming optical elements from such materials in such an environment.

The mold assemblies of the present invention can be used in operating extremes required by such high-quality optical glass. For example, by forming the molding material 14 of the present invention from a single crystal diamond, the mold assembly can withstand repeated usage at temperatures above 400° C. In one embodiment of the invention, the single crystal diamond can range in size up to about 5 mm across a width W of the working surface 16 of the molding material 14. Industrial single crystal diamonds offered by Element Six and Sumitomo Electric have been effectively incorporated into the press molds of the present invention.

In one aspect of the invention, the octahedral face (111) face of the single crystal diamond can be oriented (e.g., exposed) toward a compression axis (shown by arrow 20 in FIG. 1) of the mold assembly. In this configuration, the single crystal diamond has the highest bulk modulus of any orientation, resulting in the mold exhibiting virtually incompressible and un-deformable characteristics. In another embodiment, the cubic face (100) can be oriented toward the compression axis. In cases where the mold assembly is to be used in temperatures exceeding 600° C., the operations can be performed under a protected atmosphere (e.g., nitrogen or argon) to prevent the single crystal diamond from oxidizing at these elevated temperatures. The working surface 16 of the single crystal diamond can be formed in a variety of manners. In one aspect, the working surface can be ground to form the shape corresponding to the optical element shape. The ground curvature can be finished by polishing with diamond micron powder in cooperation with a metal polishing surface matched with the shape of the working surface and aided by ultrasonic vibrations.

The superhard single crystal diamond mold can be used to make glass lenses having very tight tolerances. Because the mold is not as susceptible to yielding during compression as conventional molds, residual stresses formed within the glass are greatly reduced or eliminated. In this case, the lens will be isotropical, i.e. it can have a refractive index that is independent of direction. While single crystal diamond molds may be relatively expensive to product, the life of the single crystal mold can be hundreds of times longer than conventional mold assemblies, resulting in a unit production cost that is lower than conventional mold assemblies.

The support material 12 can be formed from a variety of materials suitable for supporting the superhard molding material 14. In general, the support material must be a relatively rigid material that can bond well with the superhard molding material. In one aspect of the invention, the support material is formed of cWC or ceramic materials (e.g., SiC, Si3N4, AlN, etc.) or hardened steel.

The superhard molding material can be bonded or otherwise attached to the support material in a variety of manners as well. For example, a braze 30, such as an AgCuTi alloy (or TiCuSi₁ or CuSnTi) can be used to bond the single crystal diamond to the support material. To improve the bonding interface, the chemical bonding of the molding material to the support material, can be performed under vacuum (e.g. 10⁻⁵ torr) at relatively high temperatures (e.g., 950° C.).

As discussed above, in one aspect of the invention, the (111) face of the single crystal diamond can be oriented (e.g. exposed) toward the compression axis of the mold assembly. In this embodiment, the working surface of the diamond is the least reactive face of the diamond. The (111) working surface can be made even less reactive by treating the surface with a plasma of hydrogen, nitrogen or fluorine to mate with the dangling electrons on the diamond's (111) face. The dangling bonds can be bound to an element having only a single valence electron, which can be hydrogen or a halogen. The halogen can be selected from the group consisting of F, Cl, Br, I, and mixtures thereof.

Such surface treatment can increase the chemical inertness and thermal stability of the working surface of the molding material. Further details of such surface treatment can be found in presently pending U.S. patent application Ser. No. 10/268,016, filed Oct. 08, 2002, which is hereby incorporated herein in its entirety.

Turning now to FIG. 2, in one aspect of the invention, a mold assembly 10a for forming optical elements is provided, including a support material 12 and a molding material 14a. In this embodiment of the invention, the molding material can include a PCD compact which is coupled to the support material 12. The PCD molding material can include a working surface 22 which can define a shape to be imparted to an optical element (not shown) to be pressed in the mold assembly. A superhard film 24 can be applied over the working surface of the PCD molding material to provide a smoother interface between the mold assembly and the optical element. Optical molds in accordance with this embodiment of the invention have been successfully used to form optical lenses having a width or diameter on the order of 5 to 50 mm.

The PCD molding material 14a can be of a variety of materials but is generally a very rigid material that can provide a good bonding interface for the superhard film 24. In one aspect of the invention, the PCD molding material comprises a plurality of diamond particles sintered into a unified mass with a sintering aid. The sintering aid can be a ceramic material selected from the group consisting of: SiC, TiC, TiN, Si₃N₄, AlN, WC and Al₂O₃. As the PCD molding material is generally formed of a material that is difficult and expensive to machine, an electrically conducting metal can be included in the sintering aid to facilitate electrical discharge machining of the PCD. In one embodiment of the invention, the electrically conducting metal can include Ni, Ti or W.

It has been found that conventional high pressure sintered PCD with cobalt as the sintering aid is not generally suitable for making the lens mold. This is because cobalt will often back-convert diamond to become amorphous carbon above a temperature of about 700° C. This back conversion will expand the PCD grains and create micro cracks in the mold surfaces. In addition, soft cobalt inclusions on the surface of the PCD can react due to the repeated flow of glass into and out of the mold assembly. As a result, surface of the PCD can become pitted and consequently the surface of lenses formed in the mold may not be sufficiently smooth.

However, silicon infiltrated diamond grains can form a PCD with a SiC matrix that is very hard. In fact, it has been found that a high-pressure sintered diamond-SiC composite can be used as the working surface of the lens mold even without the addition of a superhard film over the PCD. In this case, it is preferable that the grain size of the diamond be maintained at a relatively small (e.g. 1 micron) size. As discussed above, Diamond-SiC composite is normally electrically insulating, requiring that it be laser cut instead of machining by more convenient methods such as by wire EDM or EDG. However, the infiltrated silicon alloy may contain metal (e.g. Ni, Ti, W) so the composite is electrically conducting. In this case, the shaping of the superhard composite into the shape corresponding to the shape of the optical element to be formed in the press mold can be more easily formed by EDM or EDG.

Another mold material used in the present invention is polycrystalline cubic boron nitride (PcBN) that is a sintered composite material of cBN and ceramics (e.g. AlN, TiC, TiN, TiB₂, Si₃N₄, Al₂O₃). The volume content of cBN can range from 95% down to 40%. For the present mold material design, high cBN content has been found to perform better. PcBN is not generally as hard as PCD, so it can be ground with diamond wheels into a desired shape and surface texture. The surface of PcBN may also be coated with diamond film or DLC. In this case, the surface coating can smooth any cBN grains as well as non-cBN ceramic matrix.

The superhard film 24 can be formed of a variety of materials and can be attached to the support material 12 in a variety of manners. In one aspect of the invention, the superhard film can be CVD diamond deposited by a variety of methods, such as by hot filament, microwave plasma, radio wave plasma, or DC arc. Typically, a carbonaceous gas (e.g. methane, acetylene) is used as the carbon source, and ample hydrogen (e.g. 99 V %) is used as the precursor of the catalyst. The gas mixture is decomposed by one of the above-described energy sources. The dissociated hydrogen atoms will preserve the decomposed carbon in diamond-like bonding configuration and eventually these carbon atoms will connect to form diamond film.

Thus, the diamond film can be a polycrystalline structure. In order to minimize the subsequent grinding work required to provide a smooth lens mold, the nucleation rate can be enhanced to reduce the grain size so the resulting surface is not as rough as with conventional diamond films. There are several manners in which the nucleation rate can be enhanced. Typical diamond film will deposit with a nucleation density of less than about one million per square centimeter. By polishing the substrate with micron diamond in an ultrasonic bath of a liquid (e.g. acetone), the nucleation rate may be increased up to a thousand fold. If nano diamond (e.g. 5 nm dynamite explosion made) is used in the ultrasonic bath, the nucleation rate may be increased by up to about another thousand times. The diamond nucleation rate may also be increased by up to about a million fold by applying a negative electrical bias (about 100-200 volts) to the substrate while diamond film is deposited.

In general, the faster the nucleation rate, the smaller the diamond grains that are formed. When the diamond size is reduced to nanom (nanometer) range, the diamond film deposited on the molding material is very smooth, requiring minimal polishing work when completed. One manner in which nanom diamond can be deposited is by increasing methane content in the gas phase from about 2V % to over 30V %. By so doing, the process can reduce the deposit temperature from a typical value of about 800-900° C. down to about 600-700° C. In this case, diamond will continue to nucleate without growth so the diamond film will contain nanom grain size.

Another example is to eliminate the use of hydrogen gas altogether so that diamond nuclei cannot grow at all. In this case, methane (about 1V %) is mixed with about 99V % argon or nitrogen and energized by a CVD process (e.g. microwave). The dissociated methane will form diatomic carbon that will be laid down as diamond nuclei. The resulting nanom diamond films that are formed are generally transparent with high quality. They have been found to be very well suited for making mold faces.

Another way to reduce the grinding or polishing effort of diamond film is to dope CVD diamond with boron. Diamond is normally an electrical insulator. But boron doped diamond (BDD) is electrically conducting, similar to a semimetal. In this case, the film can be ground or polished by electrically discharged machining. The diamond film is bombarded with electrical arc from a cathode that is shaped to form the mold cavity. Electrically discharged machining or grinding is highly effective so the time and cost spent can be drastically reduced.

In yet another aspect of the invention, a low temperature vapor deposition process can be a conformal diamond coating process. Conformal diamond coating processes can provide a number of advantages over conventional diamond film processes. Conformal diamond coating can be performed on a wide variety of substrates, including non-planar substrates. A growth surface can be pretreated under diamond growth conditions in the absence of a bias to form a carbon film. The diamond growth conditions can be conditions which are conventional CVD deposition conditions for diamond without an applied bias. As a result, a thin carbon film can be formed which is typically less than about 100 angstroms. The pretreatment step can be performed at almost any growth temperature such as from about 200° C. to about 900° C., although lower temperatures below about 500° C. may be preferred. Without being bound to any particular theory, the thin carbon film appears to form within a short time, e.g., less than one hour, and is a hydrogen terminated amorphous carbon.

The carbon film can be seeded with nanodiamond using ultrasonic agitation of a dispersion of nanodiamond powder to form a seeded substrate. The dispersion can generally be a dispersion of nanodiamond in methanol although any suitable dispersion can be used. Excess nanodiamond can be removed by washing. Seeding in this manner can achieve very high nucleation densities, e.g. exceeding 10¹¹/cm².

The seeded substrate can be subjected to diamond growth conditions to form the diamond film as a conformal diamond film. The diamond growth conditions can be those conditions which are commonly used in traditional CVD diamond growth. However, unlike conventional diamond film growth, the diamond film produced using the above pretreatment steps results in a conformal diamond film. Further, the diamond film typically begins growth substantially over the entire substrate with substantially no incubation time. In addition, a continuous film, e.g. substantially no grain boundaries, can develop within about 80 nm of growth.

Although suitable conditions can vary, process temperatures in this aspect of the invention can be held below about 500° C. with good results. For example, temperatures from about 250° C. to about 500° C. can be useful and from about 300° C. to about 450° C. may generally be preferred. Growth conditions do not need to be the same as those used during the pretreatment step and can vary substantially therefrom. For example, conventional CVD diamond growth conditions can be used in the pretreatment step to form the thin carbon film, while plasma or laser ablation conditions can be used during the growth step.

The above described examples of single crystal diamond and polycrystalline diamond films can be substantially pure diamond that are ideal for forming the molding material 14a and/or the working surface 16. Their surface can be polished to nanom or even angstroms level finish. Such surface may also be passivated by the termination of hydrogen, nitrogen, or fluorine. Above all, their temperature stability can be as high as 1200° C. under a non-oxidizing environment (e.g. vacuum or purged with helium, nitrogen, or hydrogen). Consequently, they are very well suited for press-forming optical lenses at high temperatures.

The typical mold life for making glass lenses at 700° C. is often only 10-30 for hardened steel and often only 100-300 for cemented tungsten carbide. It is predicted that the service life of the mold assemblies of the present invention can be over one million cycles. Hence, although the present diamond molds may be 10 times more expensive than conventional cWC molds, the production cost per lens is actually much less. Moreover, the uninterrupted operation without frequent machine “down time” for replacement of mold components will boost the manufacturing throughput significantly. Above all, the quality of lenses produced will also be markedly improved because the unyielding diamond mold faces will maintain very tight tolerances. The rigidity of the diamond will concentrate the pressure during pressing of the mold so the flow of the glass bead is hydrostatic with minimal shear stress. As the result, the refractory index of the lenses produced is highly isotropic. The nearly totally inert diamond face will also make the lens surfaces very smooth.

In one aspect, the superhard CVD film 24 on the working surface 22 of the molding material 14 may be diamond-like carbon (DLC). While DLC cannot normally adhere well to known lens mold substrates, and often delaminates upon pressure cycles under high temperature, DLC can adhere very well to diamond and to SiC. This is particularly true with the strong backing of diamond-SiC substrate and under vacuum or non-oxidizing atmosphere. Also, a superhard diamond film can be applied to the mold surface to provide a superhard finish to the mold surface. The diamond-like carbon film can include nitrogen to aid in the formation of CN. Nitrogenated DLC can be thermally stable up to about 700° C.

In the examples illustrated in the figures, the molding material 14, 14a is at least partially inset within the support material. In other embodiments of the invention, the molding material is completely inset within the support material, or is coupled to a top portion of support material. Additionally, a flash of noble metal can be applied to the working surface of the molding material of any of the embodiments discussed in order to further smooth the surfaces of the optical element as it is formed in the mold assembly.

In accordance with another embodiment, the present invention can also provide a mold assembly for forming at least partially spherical elements, such as roller or ball bearing components, optical lenses, and a variety of other elements that require very smooth working surfaces. In one aspect of this embodiment, the mold assembly can include a support material and a molding material coupled to the support material. The molding material can be capable of shaping a material when subject to pressure in excess of 10 MPa and temperature in excess of 100° C. The molding material can include a surface that is substantially continuous and substantially uniform in hardness.

As used herein, the term “substantially continuous” is to be understood to refer to a condition in which the molding material is substantially free of microcracks or grain boundaries. As used herein, the term “substantially uniform in hardness” is to be understood to refer to a condition in which substantially no “soft spots” occur in the molding material, as might be the case, for example, when cemented tungsten carbide is utilized which can result in areas of significantly softer material in and around the hard matrix otherwise provided by a mold assembly component formed with cemented tungsten carbide.

In addition to the embodiments discussed above, the present invention also provides a mold assembly, not explicitly shown in the figures, for forming optical elements that includes a support material and a molding material coupled to the support material. The molding material can include a first, working region, a second region, and a transition region. The first, working region can include a superhard material and can have a working surface defining a shape to be imparted to an optical element to be pressed in the mold assembly. The transition region can connect the first and second regions and can have a compositional gradient from the first region to the second region. Optical molds in accordance with this embodiment of the invention have been successfully used to form optical lenses having a width or diameter on the order of 50 mm and greater.

The mold assembly of this embodiment of the application can be formed by applying a cermet composite coating (CCC) onto ceramic or cermet materials (e.g. cemented WC). In this aspect, the CCC can “grade” from metal (e.g. W) to ceramic (e.g. SiC), or can grade from ceramic to ceramic. This aspect of the invention can be advantageous for a variety of reasons. For example, the coating applied to the support material is generally without a weak boundary layer as it blends in with, or “grades” to, the substrate. In this manner, the coating is less susceptible to peeling away form the substrate. The coating is also substantially continuous with no grain boundaries, resulting in less “pitting” of the coating surface. As discussed in relation to the above embodiments, a DLC coating or a CVD diamond film may be over-coated on the CCC material to provide additional smoothness to the CCC mold surfaces.

The first, working region of this embodiment of the invention can include ceramic materials, diamond-containing materials (e.g., DLC), and/or composites thereof. The second region can include a ceramic material which can include SiC, Si₃N₄ and WC, and composites thereof. The compositional gradient can be a continuous or a discontinuous compositional gradient.

Further discussion of specific types of CCC materials suitable for use in the present invention, and methods of forming the same can be found in currently pending U.S. patent application Ser. No. 10/837,242, filed Apr. 30, 2004, which is hereby incorporated herein in its entirety.

In addition to the structural elements disclosed above, the present invention also provides a method for forming an optical element, comprising the steps of: obtaining a mold assembly as taught above; disposing a portion of unformed optical material on the working surface of the molding material; and pressing the optical material in the mold assembly at a temperature sufficiently high to enable the optical material to flow.

The following examples present various methods for making the molds of the present invention. Such examples are illustrative only, and no limitation on the present invention is meant thereby.

### EXAMPLES

### Example 1

Micron (about 2-6 micron) diamonds are mixed with tungsten powder and subject to about 6 GPa pressure and about 1500° C. temperature for about 20 minutes. The PCD produced has a cylindrical form with a diameter of about 30 mm and a height of about 20 mm. Due to the presence of W, the PCD is electro-discharge formed to create a depression therein. Subsequently, the depression is ground with diamond tools and lapped/polished with diamond powder of decreasing size to achieve a mirror finish. The mold so formed can be used directly or it can be further coated with diamond film or cermet composite.

### Example 2

A sintered cylinder is used as the mold material. It is formed with a cavity and smooth finish. The surface is coated with cermet composite coating that grades the composition from SiC to Tantalum so the surface has little or no grain boundary.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A mold assembly for forming at least partially spherical elements, comprising:
a support material; and
a superhard molding material coupled to the support material;
the molding material being capable of shaping a material when subject to pressure in excess of 10 MPa and temperature in excess of 100° C., and including a surface that is substantially continuous and substantially uniform in hardness.

2. The mold assembly of claim 1, wherein the molding material comprises a single crystal diamond coupled to the support material, the molding material including a working surface defining a shape to be imparted to an optical element to be pressed in the mold assembly.

3. The mold assembly of claim 1, wherein the molding material comprises a PCD compact coupled to the support material, the PCD compact including a working surface defining a shape to be imparted to an optical element to be pressed in the mold assembly; and a superhard film applied over the working surface of the PCD molding material, the superhard film providing a smooth interface between the mold assembly and the optical element.

4. The mold assembly of claim 2, wherein a (111) face of the single crystal diamond is oriented toward an axis of compression of the mold assembly.

5. The mold assembly of claim 3, wherein the superhard film is a diamond film or a diamond-like carbon film.

6. The mold assembly of claim 5, wherein the diamond-like carbon film includes nitrogen.

7. The mold assembly of claim 3, wherein the PCD compact includes ceramic material as a sintering aid selected from the group consisting of: SiC, TiC, TiN, Si₃N₄, AlN, WC and Al₂O₃.

8. The mold assembly of claim 7, wherein the PCD further includes an electrically conducting metal to facilitate electrical discharge machining of the PCD.

9. The mold assembly of claim 8, wherein the electrically conducting metal includes Ti or W.

10. The mold assembly of either of claim 2 or claim 3, wherein the molding material is brazed to the support material.

11. The mold assembly of claim 10, wherein the braze comprises TiCuSi₁ or CuSnTi.

12. The mold assembly of claim 10, wherein the molding material is brazed to the support material under vacuum.

13. The mold assembly of either of claim 2 or claim 3, wherein the molding material is at least partially inset within the support material.

14. The mold assembly of either of claim 2 or claim 3, wherein the support material is selected from the group consisting of: cWC; SiC, Si₃N₄, and hardened steel.

15. The mold assembly of either of claim 2 or claim 3, wherein the working surface of the molding material is rendered non-reactive by the removal of dangling bonds from the working surface.

16. The mold assembly of claim 15, wherein the dangling bonds are bound to an element having only a single valence electron.

17. The mold assembly of claim 16, wherein the element having a single valence electron is hydrogen or a halogen.

18. The mold assembly of claim 17, wherein the halogen is a member selected from the group consisting of: F, Cl, Br, I, and mixtures thereof.

19. The mold assembly of either of claim 2 or claim 3, further comprising a flash of noble metal applied to the working surface of the molding material, the noble metal being configured to further smooth the optical element as it is formed in the mold assembly.

20. A mold assembly for forming optical elements, comprising:
a support material;
a molding material coupled to the support material, the molding material including:
a first, working region including a superhard material and having a working surface defining a shape to be imparted to an optical element to be pressed in the mold assembly;
a second region; and
a transition region connecting the first and second regions, the transition region having a compositional gradient from the first region to the second region.

21. The mold assembly of claim 20, wherein the first, working region comprises a member selected from the group consisting of: ceramic and diamond-containing materials, and composites thereof.

22. The mold assembly of claim 20, wherein the second region comprises a ceramic material.

23. The mold assembly of claim 22, wherein the ceramic material is selected from the group consisting of SiC, Si₃N₄, WC and composites thereof.

24. The mold assembly of claim 20, wherein the first, working region comprises a diamond-containing material.

25. The mold assembly of claim 24, wherein the diamond-containing material is diamond-like carbon.

26. The abrasive composite tool of claim 20, wherein the compositional gradient is a continuous compositional gradient.

27. The mold assembly of claim 20, further comprising a flash of noble metal applied to the working surface of the molding material, the noble metal being configured to further smooth the optical element as it is formed in the mold assembly.

28. A method for forming an optical element, comprising the steps of:
obtaining a mold assembly as claimed in any of claims 2, 3 or 20;
disposing a portion of unformed optical material on the working surface of the molding material; and
pressing the optical material in the mold assembly at a temperature sufficiently high to enable the optical material to flow.
